(19) United States
(12) Patent Application Publication
(10) Pub. No.: US 2026/0311146 A1
(43) Pub. Date: Oct. 8, 2026

(54) ELECTRONIC NOTARY JOURNAL

(71) Applicant: JIMMY WAGNER, Brooklyn, NY (US)

(72) Inventor: JIMMY WAGNER, Brooklyn, NY (US)

(21) Appl. No.: 19/697,518

(22) Filed: Jun. 3, 2026

Related U.S. Application Data
(63) Continuation-in-part of application No. 18/454,634, filed on Aug. 23, 2023, now abandoned.
(60) Provisional application No. 63/447,286, filed on Feb. 21, 2023.

(51) Int. Cl. G06Q 20/02; G06Q 50/18

(52) U.S. Cl. CPC G06Q 20/02; G06Q 50/18

(57) ABSTRACT

A system and method for electronically managing a notarization journal by a notary public, comprising electronically verifying details of signers and witnesses including identity documents against a third-party database in real-time. The system captures and processes notarization transaction data, including geospatial and temporal information, and generates a unique cryptographic hash of this data. This hash is then securely recorded on a distributed ledger to ensure the immutability and integrity of the notarization records, thereby providing a tamper-proof and auditable electronic journal. The system also features an automated user interface flow for efficient data capture and management, and enables automated indexing and retrieval of records.

### CROSS REFERENCE TO RELATED APPLICATIONS

This application is a continuation-in-part of a U.S. patent application Ser. No. 18/454,634 filed on Aug. 23, 2023, which claims priority from a U.S. Provisional Patent Appl. No. 63/447,286, filed on Feb. 21, 2023, both of which are incorporated herein by reference in its entirety.

### FIELD OF INVENTION

The present invention relates to a system and method for creating and maintaining an electronic notary journal, and more particularly, to a system and method for verifying presented identifications, self-populating the electronic journal, maintaining secure digital signatures, and ensuring the integrity and immutability of notarization records through distributed ledger technology.

### BACKGROUND

Notaries public play an important role in verifying the identity of signatories and witnessing the execution of legal and commercial documents. Conventional notary journal systems typically rely on paper-based records in which transaction details, identification information, document descriptions, and signatures are manually recorded. Such manual processes can be time-consuming, susceptible to human error, and vulnerable to loss, theft, deterioration, or unauthorized alteration. In addition, physical journals may be cumbersome to maintain and transport, and the information contained therein may be difficult to search, retrieve, or audit efficiently.

Existing paper-based notary journal practices also present challenges with respect to identity verification, record integrity, and fraud prevention. Verification of identification credentials often requires manual inspection without access to real-time validation resources, increasing the risk of fraudulent transactions. Furthermore, traditional journals generally lack mechanisms for ensuring the authenticity, immutability, and long-term preservation of recorded entries. As a result, disputes regarding notarized transactions may be difficult to resolve, and the evidentiary value of journal records may be diminished.

Accordingly, there exists a need for an electronic notary journal system that securely captures and stores notarial transaction information, facilitates efficient record management, supports enhanced identity verification processes, and provides tamper-resistant recordkeeping capabilities. Such a system would improve the reliability, accessibility, and integrity of notarial records while reducing administrative burdens associated with conventional paper-based journals.

### SUMMARY OF THE INVENTION

The following presents a simplified summary of one or more embodiments of the present invention to provide a basic understanding of certain features and advantages thereof. This summary is not an exhaustive overview of all contemplated embodiments and is not intended to identify key or critical elements of the invention or to delineate the scope of the claims. Rather, it introduces selected concepts that are further described in the detailed description.

Disclosed are computer-implemented systems and methods for electronic notary journal management, identity verification, transaction authentication, and secure record preservation. In various embodiments, the disclosed system enables a notary public to electronically create, manage, verify, authenticate, store, retrieve, and audit notarial transaction records using a portable computing device and one or more remote computing systems.

In some embodiments, the system receives information associated with a notarial transaction, including information relating to one or more signatories, witnesses, documents, and notarial acts. The system may acquire images of identification credentials, extract identification information from the images, and verify the extracted information using one or more external verification sources, including governmental databases, public records repositories, identity-verification services, or combinations thereof.

In various embodiments, the system captures electronic signatures associated with transaction participants and may authenticate the signatures using one or more authentication mechanisms including electronic Know Your Customer (eKYC) systems, biometric verification systems, digital certificates, public key infrastructure (PKI) systems, mobile identity credentials, or combinations thereof. Verified participant information and authenticated signatures may be associated with corresponding journal records.

In some embodiments, the system automatically obtains timestamp information and geographic location information associated with one or more transaction events. Geographic location information may be obtained for a notary public, one or more signatories, one or more witnesses, or combinations thereof. The system may generate event records corresponding to activities performed during the notarial transaction, including identification capture, document scanning, signature capture, identity verification, witness acknowledgment, and journal-entry creation. Each event record may be associated with corresponding timestamps, geographic location information, participant identifiers, and transaction identifiers.

In certain embodiments, the system correlates timestamp and geographic location information associated with multiple transaction events to generate a transaction-authenticity record indicative of whether the transaction was performed in accordance with one or more authentication criteria. The generated transaction-authenticity record may be used to authenticate participation of the notary public, signatories, and witnesses, detect anomalous transaction activity, and provide evidentiary support for audits, investigations, and legal proceedings.

In various embodiments, the system generates electronic journal entries comprising participant information, document information, identity-verification results, signatures, timestamps, geolocation information, audit information, and transaction metadata. The journal entries may be indexed using one or more searchable attributes to facilitate efficient retrieval and management of stored records.

In some embodiments, the system generates cryptographic integrity values associated with journal entries and transaction events. The cryptographic integrity values may be stored within tamper-evident audit records, blockchain systems, distributed ledger systems, hash-linked record structures, Merkle-tree structures, or combinations thereof. Such mechanisms facilitate verification of record authenticity and detection of unauthorized modifications.

In various embodiments, journal records are encrypted and stored within one or more local, remote, cloud-based, distributed, or hybrid storage environments. The system may automatically manage record-retention periods, maintain redundant backup copies, generate audit logs, and preserve journal records for durations required by applicable laws, regulations, or organizational policies.

This system provides a technical solution to the technical problem of ensuring the integrity and authenticity of notarization records, which is a significant improvement over manual methods. The integration of real-time external database verification, automated data flow, and distributed ledger technology transforms the abstract idea of record-keeping into a concrete, technologically advanced, and patent-eligible application.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram showing the environment of a system, according to an exemplary embodiment of the present invention.

FIG. 2 is a block diagram showing the architecture of the system, according to an exemplary embodiment of the present invention.

FIG. 3a shows a registration screen and FIG. 3b shows a login screen of an interface, according to an exemplary embodiment of the present invention.

FIG. 4 shows a dashboard screen of the interface, according to an exemplary embodiment of the present invention.

FIG. 5 shows a log screen of the interface for entering a record, according to an exemplary embodiment of the present invention.

FIG. 6 shows the log screen after entering a first witness, according to an exemplary embodiment of the present invention.

FIG. 7 shows a signer info screen for adding a signer, according to an exemplary embodiment of the present invention.

FIG. 8 shows a camera screen to capture a photograph of an identification document, according to an exemplary embodiment of the present invention.

FIG. 9 shows a signature screen for capturing a sign, according to an exemplary embodiment of the present invention.

FIG. 10 shows a witness info screen for adding a witness, according to an exemplary embodiment of the present invention.

FIG. 11 shows an search screen of the interface, according to an exemplary embodiment of the present invention.

FIG. 12 shows a profile screen of the interface, according to an exemplary embodiment of the present invention.

### DETAILED DESCRIPTION

The subject matter of the present invention will now be described more fully with reference to the accompanying drawings, which form a part of this disclosure and illustrate specific exemplary embodiments. However, it should be understood that the subject matter may be embodied in various forms and is not limited to the specific embodiments set forth herein. Rather, these embodiments are provided by way of example to convey the scope of the invention. It is intended that the claims encompass a broad range of subject matter, including methods, devices, components, and systems. Accordingly, the following detailed description is not intended to be taken in a limiting sense.

As used herein, the term “exemplary” is intended to mean “serving as an example, instance, or illustration.” Any embodiment described as “exemplary” should not be construed as preferred or more advantageous over other embodiments. Similarly, the expression “embodiments of the present invention” does not imply that all embodiments must include all features, advantages, or modes of operation described.

The terminology used herein is for the purpose of describing particular embodiments only and is not intended to be limiting. As used herein, the singular forms “a,” “an,” and “the” include plural references unless the context clearly dictates otherwise. Furthermore, the terms “comprises,” “comprising,” “includes,” and/or “including” specify the presence of stated features, integers, steps, operations, elements, or components, but do not preclude the presence or addition of one or more other features, integers, steps, operations, elements, components, and/or groups thereof.

The following detailed description sets forth the best currently contemplated modes for carrying out exemplary embodiments of the invention. This description is not intended to be limiting, but rather to illustrate the general principles of the invention. The claims of any issued patent will define the scope of the invention.

Disclosed are computer-implemented systems and methods for electronically maintaining notary journals through a specialized digital record management platform configured to automate, secure, and validate notarial transaction records. The platform includes one or more processors, memory devices, communication interfaces, and secure data repositories that collectively execute a sequence of operations for obtaining, validating, recording, storing, indexing, and retrieving notarial transaction information. In various embodiments, the platform electronically acquires identity information from signatories and witnesses, validates the acquired information using one or more verification sources, automatically populates journal fields required by applicable notarial regulations, captures electronic signatures and associated transaction metadata, and generates a cryptographically secured journal entry.

The disclosed platform improves the functionality of conventional electronic recordkeeping systems by creating an immutable and verifiable digital journal architecture in which each journal entry is linked to a corresponding transaction record through cryptographic hashes, digital certificates, blockchain records, distributed ledger entries, or combinations thereof. The generated cryptographic records permit subsequent verification of journal integrity and provide a technical mechanism for detecting unauthorized alterations, deletions, substitutions, or corruption of journal data. As a result, the disclosed system improves electronic record security, data integrity, auditability, and evidentiary reliability relative to conventional paper-based and generic electronic recordkeeping systems.

In some embodiments, the platform further improves computerized notarial record management through automated retention, indexing, search, and retrieval functions. Journal entries may be automatically categorized according to transaction attributes, identification information, document types, timestamps, geographic information, or regulatory classifications. The system may maintain encrypted copies of journal records across one or more remote storage locations and may automatically monitor retention periods prescribed by applicable jurisdictions. Such automated processing reduces manual data entry, minimizes transcription errors, improves retrieval efficiency, and enhances long-term preservation of notarial records.

In various embodiments, journal records are maintained within a distributed computing environment comprising cloud-based servers, remote databases, edge computing devices, or combinations thereof. The system may employ synchronization protocols, cryptographic validation routines, access-control mechanisms, and tamper-detection processes that enable authorized users to securely access and verify journal records from geographically diverse locations while preserving record authenticity. By integrating identity verification, automated regulatory compliance functions, cryptographic integrity protection, and distributed electronic storage into a unified technological framework, the disclosed systems and methods provide a technical improvement to computerized notary journal management systems and electronic recordkeeping technologies.

In various embodiments, the disclosed system is configured to electronically verify information associated with a notarial transaction by communicating with one or more external data sources, including governmental databases, public records repositories, credential validation services, or other authorized verification systems. The system may automatically compare information extracted from identification credentials with information obtained from the external data sources and may generate one or more validation results indicative of identity authenticity, credential status, data consistency, or transaction risk. Such near real-time verification operations improve the accuracy of identity validation and reduce the likelihood of fraudulent or unauthorized notarizations.

In some embodiments, the disclosed system is implemented on a portable computing device, such as a smartphone, tablet, wearable device, or other network-connected electronic device. The portable computing device may execute software modules configured to capture images of identification documents, perform optical character recognition, collect electronic signatures, obtain geolocation and timestamp information, communicate with remote verification systems, and generate electronically secured journal entries. By integrating these functions into a portable computing platform, the disclosed system enables notarial transactions to be processed, verified, and recorded at the point of service without requiring subsequent manual transcription into a separate journal.

The portable computing device may further operate as an intelligent notary assistance platform by automatically presenting required journal fields, validating entered information, detecting incomplete transaction records, enforcing jurisdiction-specific compliance requirements, and synchronizing journal records with one or more remote storage systems. Such automated processing reduces manual data-entry operations, improves record accuracy, and enhances the efficiency and reliability of electronic notary journal management. The resulting system provides technological improvements in identity verification, secure electronic record generation, distributed data storage, and computerized compliance management relative to conventional paper-based notary journals and generic electronic recordkeeping solutions.

As used herein, the term “user” refers to an individual or entity authorized to access, operate, or interact with the disclosed systems and methods for electronic record management, identity verification, notarial transaction processing, or related functions. In various embodiments, a user may include a notary public, electronic notary, remote online notary, administrative personnel, supervisory personnel, authorized agents, or other authorized parties. Unless the context clearly indicates otherwise, the terms “user” and “notary public” may be used interchangeably when referring to an individual performing notarial functions through the disclosed system.

In various embodiments, the disclosed system is configured to generate, maintain, and manage a searchable electronic repository of notarial transaction records. Upon creation of a journal entry, the system may automatically associate the entry with one or more index values, metadata fields, classification tags, or searchable identifiers. Such information may include, without limitation, transaction identifiers, names of signatories, witness information, document categories, dates, times, locations, jurisdictional information, identification credential data, notary identifiers, and other transaction-related attributes. The system may store the indexed information within one or more databases configured to permit efficient retrieval of journal records using one or more search parameters, including keywords, dates, date ranges, years, locations, document types, transaction identifiers, or combinations thereof.

In some embodiments, the system automatically captures and associates contextual metadata with a journal entry at the time of record creation. The contextual metadata may include geographic location information obtained from a positioning system, such as a Global Positioning System (GPS) receiver, network-based location services, wireless communication networks, or combinations thereof. The captured location information may identify the location at which a notarial transaction was performed, initiated, completed, verified, or recorded. The system may further generate and associate timestamp information corresponding to one or more transaction events, including document presentation, identity verification, signature capture, journal entry creation, journal entry modification, record synchronization, or record retrieval events.

In various embodiments, the disclosed system maintains an audit trail associated with each journal entry. The audit trail may record creation events, access events, modification events, verification events, synchronization events, deletion requests, authorization actions, and other system activities associated with the journal entry. Each audit event may be associated with a user identifier, timestamp, device identifier, network identifier, cryptographic verification value, or combinations thereof. The audit trail may be maintained as an append-only log, cryptographically linked record chain, distributed ledger record, or other tamper-evident data structure configured to preserve a historical record of system activity. Such audit-trail functionality facilitates forensic analysis, regulatory compliance, record authentication, and detection of unauthorized access or modifications.

By automatically generating indexed record data, contextual transaction metadata, location information, timestamps, and tamper-evident audit records, the disclosed system improves the efficiency, traceability, verifiability, and integrity of computerized notarial record management relative to conventional paper-based journals and non-integrated electronic recordkeeping systems.

In various embodiments, the disclosed system provides a computerized platform for managing, verifying, and preserving notarial transaction records. The system may acquire identification information associated with signatories, witnesses, or other participants in a notarial transaction and may electronically validate the acquired information using one or more verification processes, including comparisons against external data sources, credential validation services, governmental databases, or combinations thereof. Verification results may be associated with the corresponding journal entry and stored as part of the transaction record.

The system may further collect, generate, and maintain information required by applicable notarial laws, regulations, or administrative requirements. Such information may include transaction details, identification information, document descriptions, signatures, timestamps, location information, verification results, audit records, and other transaction-related metadata. The collected information may be automatically organized into an electronic journal entry and stored within one or more secure data repositories.

In some embodiments, journal records are encrypted and maintained within a remote storage environment comprising cloud-based servers, distributed databases, redundant storage systems, or combinations thereof. The system may automatically retain the records for a configurable retention period, including retention periods exceeding ten years where required by applicable jurisdictions. The stored records may be indexed, replicated, backed up, and protected through access-control mechanisms, cryptographic validation procedures, and tamper-detection processes to facilitate long-term preservation and integrity of notarial records.

The disclosed system may further support regulatory audits, evidentiary review, authentication proceedings, and legal disputes by providing authenticated access to historical journal records, associated verification data, audit logs, timestamp information, location information, and integrity-verification records. Through the integration of electronic identity verification, automated record generation, secure long-term storage, and tamper-evident audit capabilities, the disclosed system improves the reliability, traceability, and evidentiary value of computerized notarial record management systems.

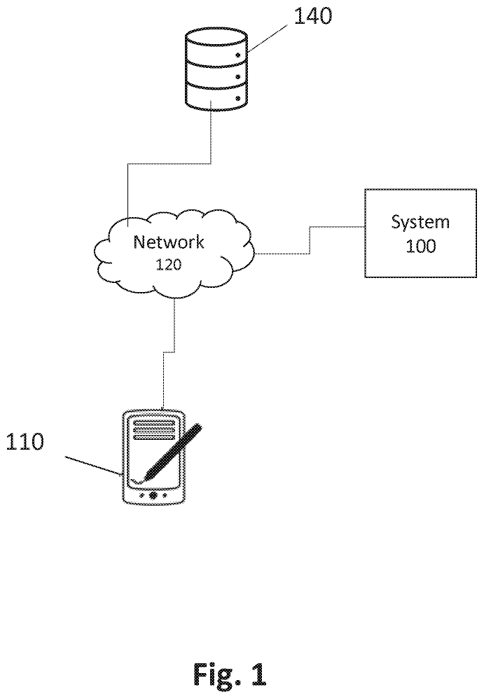

Referring to FIG. 1, an exemplary operating environment of the disclosed electronic notary journal system 100 is illustrated. The system 100 may be configured to communicate with one or more user devices 110 through one or more communication networks 120. The user device 110 may comprise a smartphone, tablet computer, laptop computer, desktop computer, wearable computing device, dedicated notarial terminal, or any other computing device capable of executing software instructions and communicating with remote computing resources. In various embodiments, the user device 110 includes one or more processors, memory devices, communication interfaces, image-capture devices, location-determination components, display devices, and user-input interfaces.

In some embodiments, the user device 110 includes a camera configured to capture images of identification credentials, documents presented for notarization, signatures, biometric information, or other transaction-related information. The user device may further include optical character recognition (OCR) modules, image-processing modules, biometric capture modules, geolocation modules, encryption modules, and secure storage modules configured to process, validate, and transmit transaction data. Information entered through the user device may be locally processed, encrypted, and transmitted to the system 100 for storage, verification, auditing, or additional processing.

The system 100 may further communicate with one or more third-party database systems 140 through the network 120. The third-party database systems 140 may include governmental databases, identity verification services, credential validation systems, public records repositories, regulatory databases, sanctions databases, fraud-detection systems, or other authorized external data sources. The system 100 may electronically transmit identification information, extracted credential data, biometric information, transaction metadata, or combinations thereof to the third-party database systems 140 and may receive verification data, validation results, risk indicators, status information, or authentication records in response. Such communications may be performed in near real-time to facilitate automated identity verification and fraud detection.

The network 120 may comprise one or more wired networks, wireless networks, or combinations thereof. Examples include local area networks (LANs), wide area networks (WANs), the Internet, cellular communication networks, Wi-Fi networks, satellite communication networks, optical communication networks, private networks, virtual private networks (VPNs), and other communication infrastructures. Although FIG. 1 illustrates a single user device 110 communicating with the system 100, it should be understood that any number of user devices may communicate with the system simultaneously or asynchronously through one or more communication networks. Further, a particular user device may utilize multiple communication channels concurrently, such as a combination of cellular and Wi-Fi communications.

In various embodiments, the system 100 is implemented using one or more server systems that may be co-located or geographically distributed across multiple computing environments. The server systems may include application servers, database servers, authentication servers, storage servers, cloud-computing resources, edge-computing resources, virtual machines, containers, or combinations thereof. The server systems may execute software modules configured to perform journal generation, identity verification, data indexing, metadata generation, audit logging, retention management, compliance validation, cryptographic processing, record synchronization, and transaction monitoring.

In some embodiments, the system 100 employs cryptographic integrity mechanisms to protect journal records and associated transaction data. For example, journal entries may be associated with cryptographic hashes, digital signatures, hash chains, blockchain records, distributed ledger records, Merkle-tree structures, or other integrity-verification data structures. Such mechanisms may permit detection of unauthorized modifications, deletions, substitutions, or corruption of stored records and may provide a verifiable historical record of journal activity. The disclosed architecture thereby improves the security, integrity, traceability, and auditability of electronic notary journal records maintained within the system 100.

In some embodiments, the system 100 is configured to obtain geographic location information associated with one or more participants in a notarial transaction, including a notary public, one or more signatories, one or more witnesses, or combinations thereof. The location information may be obtained from Global Positioning System (GPS) receivers, assisted GPS systems, cellular network positioning systems, Wi-Fi positioning systems, satellite navigation systems, beacon-based positioning systems, or other location-determination technologies incorporated into or accessible by the respective user devices. The system may automatically acquire the geographic coordinates of the participating devices at one or more stages of the notarial transaction, including identity verification, document presentation, signature capture, witness acknowledgment, journal entry creation, and transaction completion.

The acquired location information may be associated with corresponding participant identifiers, device identifiers, timestamps, transaction identifiers, and journal entries. In some embodiments, the system stores separate location records corresponding to the notary public, each signatory, and each witness participating in the transaction. The system may further determine relative proximity between the participants, verify whether one or more participants are present within a predetermined geographic region, and identify discrepancies between expected and actual participant locations.

In certain embodiments, the location information is cryptographically associated with the journal entry and maintained as part of a tamper-evident audit record. The stored location information may be used to authenticate the circumstances of a notarial transaction, establish the geographic location at which one or more transaction events occurred, support regulatory compliance requirements, assist in fraud detection, and provide evidentiary information in connection with audits, investigations, disputes, or legal proceedings. The location information may be indexed and searchable together with associated transaction records, timestamps, verification data, and participant information.

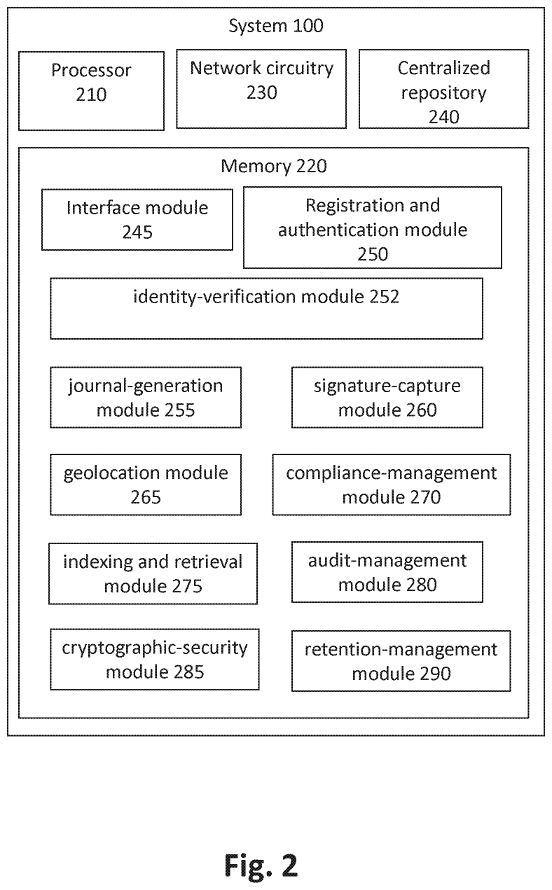

Referring to FIG. 2, an exemplary architecture of the electronic notary journal system 100 is illustrated. The system 100 may comprise one or more processors 210, one or more memory devices 220, one or more communication interfaces 230, and one or more data storage repositories 240 operatively coupled through one or more communication buses. The various components may be implemented within a single computing device, across multiple computing devices, within a cloud-computing environment, or in any combination thereof.

The processor 210 may comprise one or more microprocessors, central processing units (CPUs), graphics processing units (GPUs), digital signal processors (DSPs), application-specific integrated circuits (ASICs), field-programmable gate arrays (FPGAs), programmable logic devices, virtual processors, or combinations thereof. The processor 210 may execute machine-readable instructions stored in the memory 220 to perform the operations described herein.

The memory 220 may comprise volatile memory, non-volatile memory, cache memory, persistent storage, solid-state storage devices, magnetic storage devices, optical storage devices, cloud-based storage resources, distributed storage systems, or combinations thereof. The memory 220 may store executable instructions, transaction records, journal entries, participant information, identity verification data, audit logs, cryptographic information, geolocation information, compliance rules, indexing data, and other information associated with operation of the system 100.

The communication interface 230 may comprise wired communication circuitry, wireless communication circuitry, cellular communication circuitry, network interface controllers, radio-frequency transceivers, satellite communication interfaces, optical communication interfaces, or combinations thereof. The communication interface 230 may facilitate communications with user devices, third-party verification systems, governmental databases, cloud-based services, distributed ledger systems, and other external computing resources.

In various embodiments, the memory 220 stores a plurality of software modules executable by the processor 210. The software modules may include an interface module 245 for rending an interface on a user device; a registration module 250 for generating user profiles; an identity-verification module 252 configured to validate participant information using one or more external data sources; a journal-generation module 255 configured to create electronic notary journal entries; a signature-capture module 260 configured to acquire and process electronic signatures; a geolocation module 265 configured to obtain and process location information associated with one or more transaction participants; a compliance-management module 270 configured to validate transaction information against jurisdiction-specific requirements; an indexing and retrieval module 275 configured to organize and retrieve journal records; an audit-management module 280 configured to generate and maintain activity logs; a cryptographic-security module 285 configured to generate hashes, digital signatures, encryption keys, or other integrity-verification data; and a retention-management module 298 configured to preserve records in accordance with applicable retention requirements.

In some embodiments, the geolocation module 265 is configured to obtain geographic location information associated with a notary public, one or more signatories, and one or more witnesses participating in a notarial transaction. The geolocation module may receive location data from Global Positioning System (GPS) receivers, assisted GPS systems, cellular positioning systems, Wi-Fi positioning systems, satellite navigation systems, or combinations thereof. The processor 210 may associate the acquired location information with corresponding participant identifiers, timestamps, device identifiers, transaction identifiers, and journal records. The system may further determine whether the participants are co-located, located within a predetermined geographic area, or satisfy one or more location-based verification criteria associated with the notarial transaction.

The software modules stored in the memory 220 may operate independently or cooperatively to automate identity verification, participant authentication, journal creation, metadata generation, geolocation verification, cryptographic validation, audit logging, record indexing, secure storage, record retrieval, and regulatory compliance functions. Through execution of the software modules, the system 100 provides a specialized computing platform for secure electronic notary journal management, participant verification, and long-term preservation of authenticated transaction records.

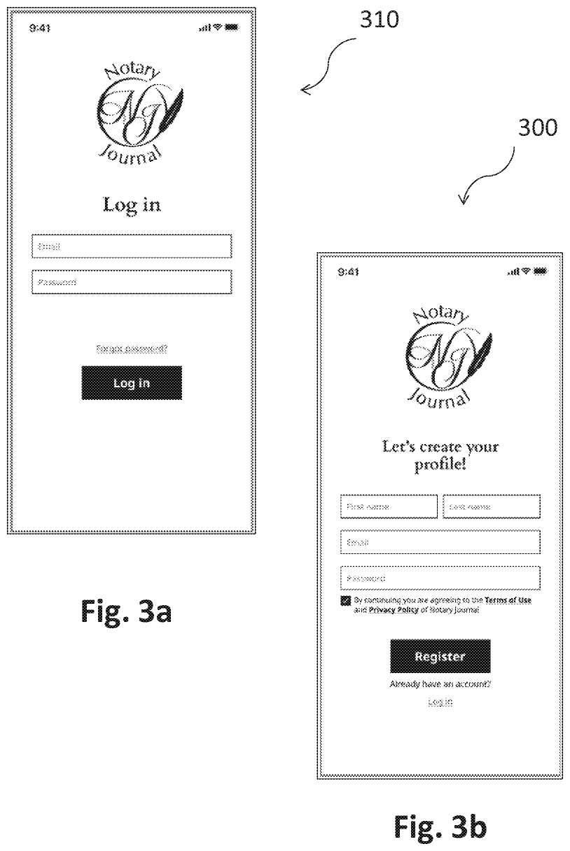

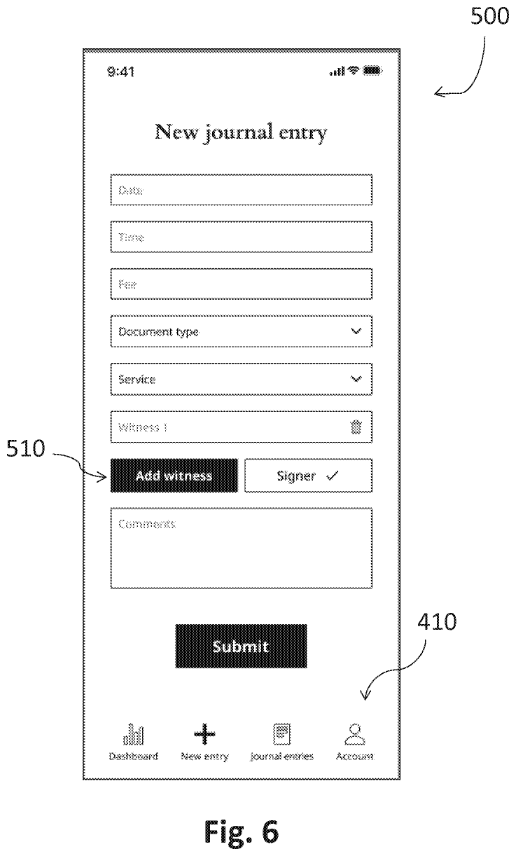

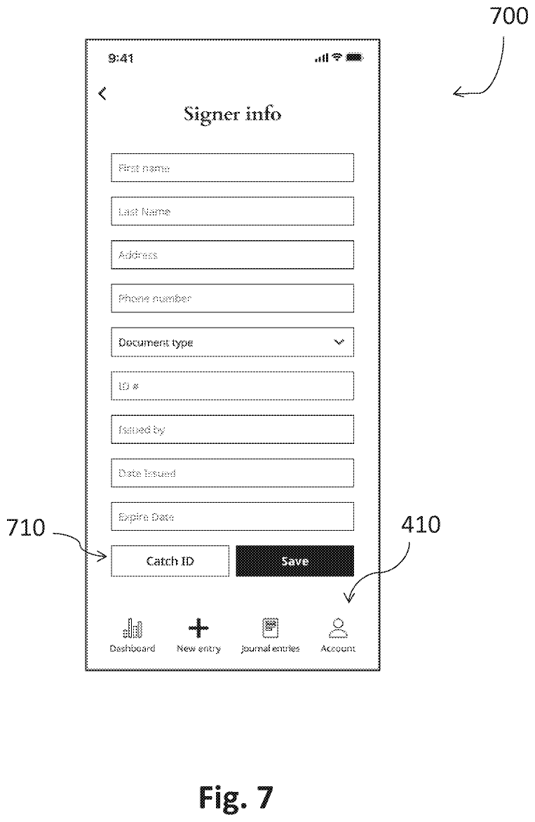

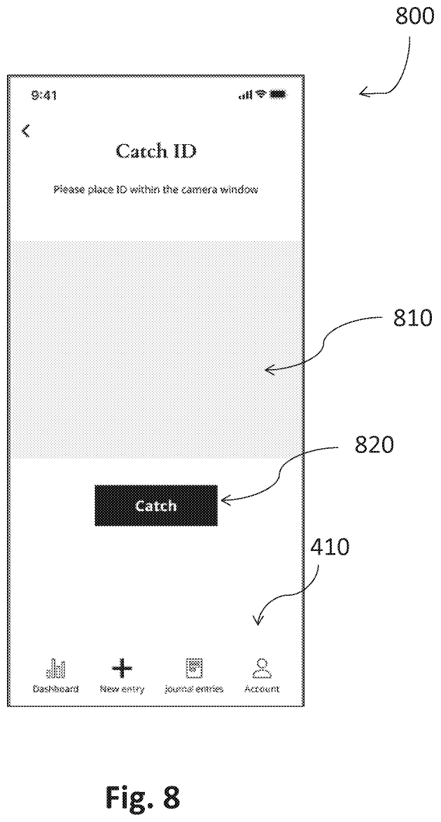

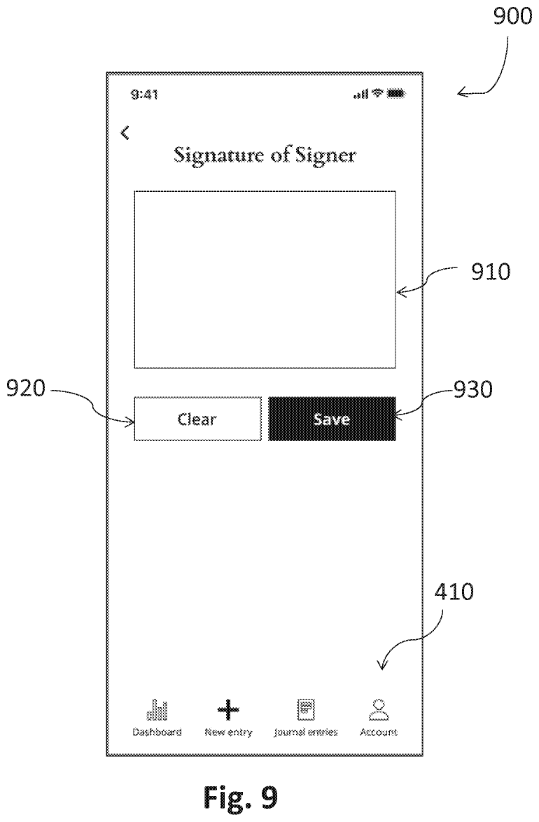

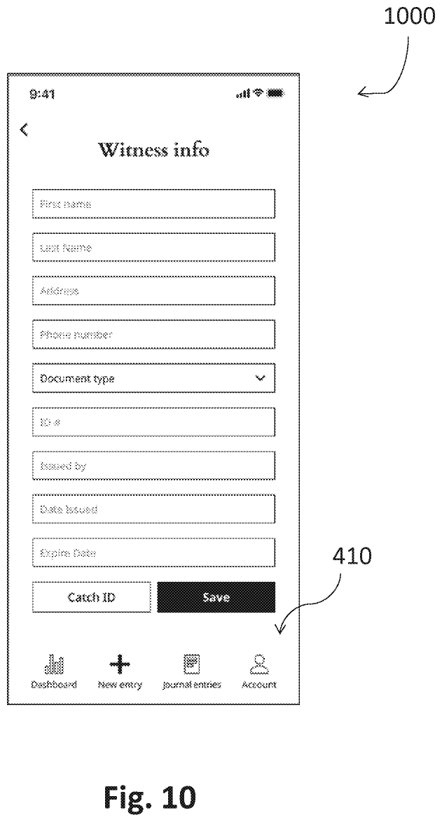

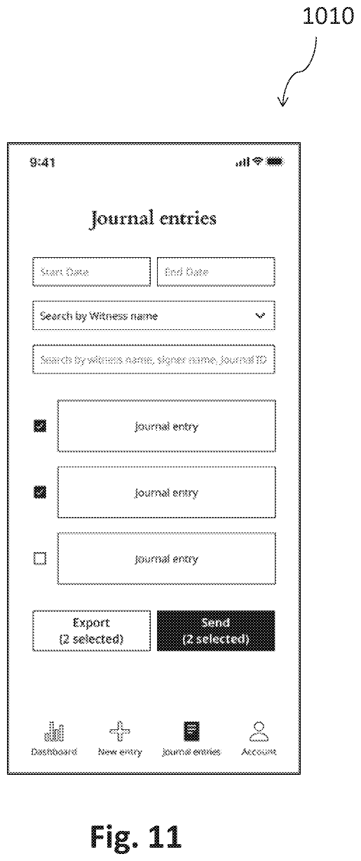

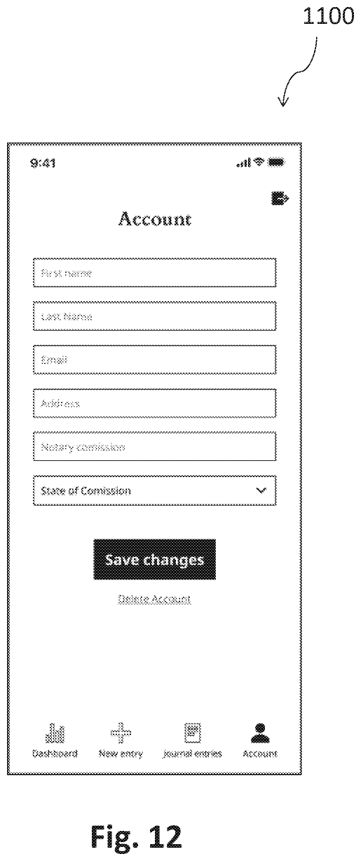

The interface module 245, when executed by the processor 210, is configured to generate and manage one or more user interfaces through which users interact with the electronic notary journal system 100. The interface module 245 may cause transaction information, verification results, compliance notifications, journal records, audit information, participant data, and other system-generated information to be presented on a user device. The interface module 245 may further receive user inputs, electronic signatures, images, identification information, location information, transaction details, and other data associated with a notarial transaction. FIGS. 3-12 illustrate exemplary user-interface screens that may be generated by the interface module 245.

In various embodiments, the interface module 245 is configured to provide a guided transaction workflow that dynamically presents data-entry fields, validation prompts, verification results, and compliance requirements based on transaction-specific conditions. The interface module may automatically determine which information is required for a particular transaction type, jurisdiction, participant category, or document type and may selectively present corresponding interface elements. Such dynamic interface generation reduces manual data-entry operations and assists users in capturing information required for completion of a notarial transaction.

The interface module 245 may further coordinate operation of one or more device resources, including cameras, image sensors, biometric sensors, geolocation components, communication interfaces, secure storage components, and signature-capture devices. For example, the interface module may invoke a camera application programming interface (API) to capture images of identification credentials or notarized documents, invoke a geolocation service to obtain location information associated with a notary public, signer, or witness, invoke signature-capture functionality to obtain electronic signatures, and invoke communication services to transmit transaction data to one or more remote computing systems for verification or storage.

In some embodiments, the interface module 245 performs client-side validation of entered information before transmission to the system 100. Such validation may include format verification, completeness verification, jurisdiction-specific compliance checks, identity-data consistency checks, duplicate-record detection, geolocation verification, and other validation operations. Validation results may be presented within the user interface in real time, thereby reducing incomplete or inaccurate journal entries.

The interface module 245 may be implemented as a native mobile application, a hybrid application, a web application, a progressive web application, a desktop application, or combinations thereof. In various embodiments, the interface module may be distributed through application distribution platforms and may be configured for execution on Android™, iOS™, Windows™, Linux™, macOS™, or other operating systems. The interface module may further communicate with one or more remote servers through secure communication channels to synchronize journal records, retrieve verification data, receive software updates, and maintain consistency between local and remote data repositories.

In certain embodiments, the interface module 245 is configured to automatically capture and display transaction metadata including timestamps, geolocation information, participant identifiers, verification status indicators, audit information, device identifiers, and transaction identifiers. The interface module may present such information in a structured format that enables efficient review, verification, retrieval, and management of electronic notary journal records. Through integration with the identity-verification, geolocation, compliance-management, audit-management, and cryptographic-security modules, the interface module provides an interactive computing environment for creation, verification, authentication, and management of electronic notarial transaction records.

The memory 220 may further store a registration and authentication module 250 executable by the processor 210. The registration and authentication module 250 may be configured to facilitate user enrollment, credential management, identity verification, authentication, authorization, account administration, and access control for the electronic notary journal system 100.

In various embodiments, a user may establish an account through a registration interface, such as registration screen 300 illustrated in FIG. 3B. During registration, the registration and authentication module 250 may receive user information including, without limitation, a name, address, contact information, professional information, notary commission information, licensing information, jurisdictional information, certification information, business information, or combinations thereof. The module may validate one or more submitted data elements through automated verification procedures, including comparisons with governmental databases, licensing authorities, certification repositories, public records databases, or other authorized verification sources.

Upon successful registration, the registration and authentication module 250 may generate or associate one or more authentication credentials with the user account. The authentication credentials may include usernames, passwords, cryptographic keys, digital certificates, biometric credentials, authentication tokens, hardware security credentials, one-time passcodes, multi-factor authentication credentials, or combinations thereof. Authentication data may be encrypted, hashed, tokenized, or otherwise protected prior to storage within the system.

In some embodiments, the registration and authentication module 250 supports multi-factor authentication procedures requiring verification through two or more independent authentication factors. For example, authentication may require a password in combination with a biometric verification process, a one-time passcode transmitted to a registered device, a cryptographic token, a digital certificate, or combinations thereof. Such authentication procedures may reduce unauthorized access to journal records and associated transaction information.

The registration and authentication module 250 may further provide account-recovery and credential-management functions. For example, the module may permit a user to reset authentication credentials, update profile information, modify security settings, register additional devices, revoke compromised credentials, regenerate cryptographic credentials, or manage authorized access permissions. Security events associated with authentication activities may be recorded within an audit log maintained by the system.

After authentication, the user may access a profile-management interface through which information associated with the user's notarial authority may be maintained. Such information may include commission numbers, commission jurisdictions, commission expiration dates, notarial certifications, licensing information, bond information, insurance information, electronic notarization authorizations, remote online notarization authorizations, or other professional credentials. In certain embodiments, the system may automatically validate or periodically revalidate such information using one or more external verification sources.

The registration and authentication module 250 may further associate authenticated user accounts with corresponding journal entries, transaction records, audit records, geolocation information, verification activities, electronic signatures, cryptographic credentials, and transaction events processed by the system. By maintaining authenticated user identities and secure access controls, the registration and authentication module 250 enhances the integrity, traceability, accountability, and security of electronic notarial transaction management.

The identity-verification module may be configured to acquire, process, and validate identity information associated with one or more transaction participants, including notaries, signatories, witnesses, or other authorized persons. The identity-verification module may receive images of identification credentials, extract information using optical character recognition (OCR) techniques, analyze security features of identification documents, compare extracted information against one or more external verification sources, and generate verification results indicative of identity authenticity, credential validity, or transaction risk. The identity-verification module may further interface with governmental databases, public records repositories, credential validation services, fraud-detection systems, biometric verification systems, or combinations thereof.

The journal-generation module 255 configured to create, organize, and maintain electronic notary journal entries. The journal-generation module may receive transaction information from one or more system components and automatically generate structured journal records containing participant information, document information, verification results, signatures, timestamps, geolocation information, audit information, and other transaction-related metadata. The journal-generation module may further assign transaction identifiers, create searchable record structures, and maintain associations between related transaction records.

The signature-capture module 260 can obtain, process, verify, authenticate, and store signatures associated with a notarial transaction. The signature-capture module may receive handwritten signatures through touch-sensitive displays, stylus-enabled devices, signature pads, mobile devices, or other input mechanisms. In certain embodiments, the signature-capture module may capture signature characteristics including stroke patterns, pressure information, velocity information, acceleration information, timing information, or combinations thereof. The captured signature data may be associated with corresponding journal entries, participant identifiers, timestamps, geolocation information, and transaction records.

In some embodiments, the signature-capture module 260 is further configured to authenticate electronic signatures using one or more electronic identity verification technologies. For example, the module may interface with electronic Know Your Customer (eKYC) systems, digital identity providers, governmental identity verification services, digital certificate authorities, public key infrastructure (PKI) systems, biometric authentication systems, mobile identity platforms, or combinations thereof. The signature-capture module may verify that a person applying an electronic signature corresponds to a previously verified identity associated with the transaction.

In various embodiments, the signature-capture module may generate, receive, validate, or store one or more digital authentication artifacts associated with an electronic signature, including digital certificates, cryptographic keys, signature verification tokens, identity-verification records, authentication logs, biometric verification results, challenge-response verification records, or combinations thereof. The authentication artifacts may be cryptographically linked to the corresponding signature record and journal entry to establish authenticity and non-repudiation.

The signature-capture module may further cooperate with the identity-verification module 252, geolocation module 265, audit-management module 280, and cryptographic-security module 285 to generate an authenticated signature record. The authenticated signature record may include identity-verification data, timestamp information, geolocation information, device information, authentication results, and cryptographic integrity information associated with the signing event. Such information may be used to verify the authenticity of the electronic signature and to provide evidentiary support during audits, investigations, administrative proceedings, or legal disputes.

In certain embodiments, the signature-capture module may generate a confidence score, authentication status indicator, trust score, or digital attestation corresponding to the electronic signature based on one or more authentication factors including eKYC verification results, biometric verification results, credential validation results, geolocation verification results, device authentication results, or combinations thereof.

The geolocation module 265 configured to obtain, process, and manage geographic location information associated with one or more participants in a notarial transaction. The geolocation module may obtain location data from Global Positioning System (GPS) receivers, assisted GPS systems, cellular positioning systems, Wi-Fi positioning systems, satellite navigation systems, beacon-based systems, or combinations thereof. In some embodiments, the geolocation module obtains current location information corresponding to a notary public, one or more signatories, and one or more witnesses at one or more stages of a transaction. The geolocation module may determine participant proximity, verify geographic presence within designated jurisdictions, identify location discrepancies, and associate acquired location information with journal records, timestamps, participant identifiers, and audit records.

The compliance-management module 270 can evaluate transaction information against one or more legal, regulatory, administrative, organizational, or jurisdiction-specific requirements. The compliance-management module may automatically determine required journal fields, identify missing information, validate participant qualifications, verify commission status, monitor record-retention requirements, generate compliance alerts, and prevent completion of transactions that fail to satisfy predetermined requirements. The compliance-management module may maintain jurisdiction-specific rulesets that are periodically updated to reflect changes in applicable laws or regulations.

The indexing and retrieval module 275 can organize, classify, search, and retrieve journal records and associated transaction information. The indexing and retrieval module may generate searchable indexes based on participant names, transaction identifiers, document categories, identification information, timestamps, locations, commission information, verification results, or combinations thereof. The indexing and retrieval module may further support keyword searching, metadata searching, filtered searching, full-text searching, and advanced retrieval operations across one or more local or distributed data repositories.

The audit-management module 280 can generate, maintain, and monitor audit records associated with operation of the system 100. The audit-management module may record transaction events, authentication events, verification events, access events, modification events, synchronization events, deletion requests, credential-management activities, and other system activities. Audit records may include timestamps, user identifiers, device identifiers, network information, geolocation information, transaction identifiers, cryptographic verification values, or combinations thereof. The audit-management module may maintain the audit records in an append-only or tamper-evident format to facilitate forensic analysis, compliance monitoring, and record authentication.

The cryptographic-security module 285 can provide data protection, integrity verification, authentication, and non-repudiation functions. The cryptographic-security module may generate cryptographic hashes, digital signatures, encryption keys, certificates, tokens, or other security credentials. The cryptographic-security module may encrypt journal records during transmission and storage, generate integrity-verification values associated with journal entries, verify record authenticity, and detect unauthorized modifications to stored information. In certain embodiments, the cryptographic-security module may interface with blockchain systems, distributed ledger systems, hash-chain architectures, Merkle-tree structures, hardware security modules (HSMs), trusted execution environments (TEEs), or combinations thereof.

The retention-management module 290 can manage preservation, archival, backup, and lifecycle administration of journal records. The retention-management module may automatically apply jurisdiction-specific retention policies, monitor retention periods, create redundant backup copies, migrate records between storage tiers, archive historical records, and prevent unauthorized deletion of records subject to retention requirements. The retention-management module may further coordinate with the indexing and retrieval module 275, audit-management module 280, and cryptographic-security module 285 to ensure long-term accessibility, integrity, and authenticity of retained journal records.

In some embodiments, the system is configured to automatically generate event-specific metadata for activities performed during a notarial transaction. Such activities may include capturing an image of a signatory, capturing an image of a witness, scanning an identification credential, scanning a document presented for notarization, obtaining an electronic signature, performing an identity-verification operation, creating a journal entry, or completing a transaction. For each event, the system may automatically obtain a timestamp and geographic location information from the user device and associate the timestamp and geographic location information with the corresponding event record.

The geographic location information may be obtained from a Global Positioning

System (GPS) receiver, assisted GPS system, cellular positioning system, Wi-Fi positioning system, satellite navigation system, or combinations thereof. The timestamp information may be obtained from the user device, a network time source, a trusted time authority, or combinations thereof. The generated timestamp and geographic location information may be stored as event metadata and cryptographically associated with the corresponding event record.

In various embodiments, the system maintains a sequence of event records corresponding to actions performed during a notarial transaction. Each event record may include an event identifier, timestamp, geographic location, participant identifier, device identifier, transaction identifier, captured content, verification results, or combinations thereof. The event records may be chronologically organized and maintained within an audit log, hash-linked record structure, blockchain record, distributed ledger record, or other tamper-evident data structure.

The system may further analyze the timestamped geographic location information associated with multiple transaction events to determine whether the events exhibit a location and timing pattern consistent with performance of the notarial transaction by an authorized notary public. For example, geographic location information associated with document scanning, identity verification, witness capture, signatory capture, and signature-capture events may be compared to determine whether the events occurred within predetermined temporal and geographic thresholds. Corroboration of multiple event-specific location records may be used to generate a digital authenticity indicator, trust score, verification record, or authentication certificate associated with the notarial transaction.

In some embodiments, the system is configured to automatically generate event-specific metadata for activities performed during a notarial transaction. Such activities may include capturing an image of a signatory, capturing an image of a witness, scanning an identification credential, scanning a document presented for notarization, obtaining an electronic signature, performing an identity-verification operation, creating a journal entry, or completing a transaction. For each event, the system may automatically obtain a timestamp and geographic location information from the user device and associate the timestamp and geographic location information with the corresponding event record.

The geographic location information may be obtained from a Global Positioning System (GPS) receiver, assisted GPS system, cellular positioning system, Wi-Fi positioning system, satellite navigation system, or combinations thereof. The timestamp information may be obtained from the user device, a network time source, a trusted time authority, or combinations thereof. The generated timestamp and geographic location information may be stored as event metadata and cryptographically associated with the corresponding event record.

In various embodiments, the system maintains a sequence of event records corresponding to actions performed during a notarial transaction. Each event record may include an event identifier, timestamp, geographic location, participant identifier, device identifier, transaction identifier, captured content, verification results, or combinations thereof. The event records may be chronologically organized and maintained within an audit log, hash-linked record structure, blockchain record, distributed ledger record, or other tamper-evident data structure.

The system may further analyze the timestamped geographic location information associated with multiple transaction events to determine whether the events exhibit a location and timing pattern consistent with performance of the notarial transaction by an authorized notary public. For example, geographic location information associated with document scanning, identity verification, witness capture, signatory capture, and signature-capture events may be compared to determine whether the events occurred within predetermined temporal and geographic thresholds. Corroboration of multiple event-specific location records may be used to generate a digital authenticity indicator, trust score, verification record, or authentication certificate associated with the notarial transaction.

In certain embodiments, the corroborated event-specific timestamps and geographic location records provide a verifiable digital evidence trail demonstrating the occurrence of transaction events at particular times and locations. The evidence trail may be used to authenticate participation of the notary public, signatories, and witnesses, detect anomalous or potentially fraudulent transactions, support regulatory audits, and provide evidentiary support in connection with investigations, disputes, or legal proceedings.

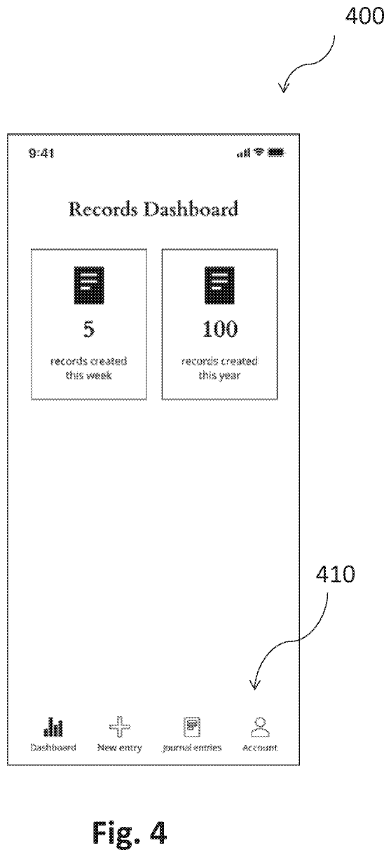

Referring to FIG. 4, upon successful authentication, the interface module 245 may present a dashboard screen 400. The dashboard screen 400 may provide a consolidated view of information associated with operation of the electronic notary journal system 100. For example, the dashboard screen may display journal-entry statistics, transaction summaries, pending verification requests, compliance notifications, retention alerts, audit notifications, storage utilization information, and other system-generated information. The dashboard screen may further provide access to journal-creation functions, search functions, record-management functions, account-management functions, and administrative functions. In some embodiments, the dashboard screen receives information from the journal-generation module 255, compliance-management module 270, audit-management module 280, and retention-management module 290 to provide real-time operational status information.

The interface may further include a navigation component 410 configured to facilitate access to various functions of the system. The navigation component may remain accessible across multiple interface screens and may provide links to journal-entry creation interfaces, record-search interfaces, account-management interfaces, audit interfaces, reporting interfaces, or other system functions. Although illustrated as a bottom-positioned menu bar, the navigation component may be implemented in any suitable form including side panels, floating controls, gesture-based controls, voice-activated controls, or combinations thereof.

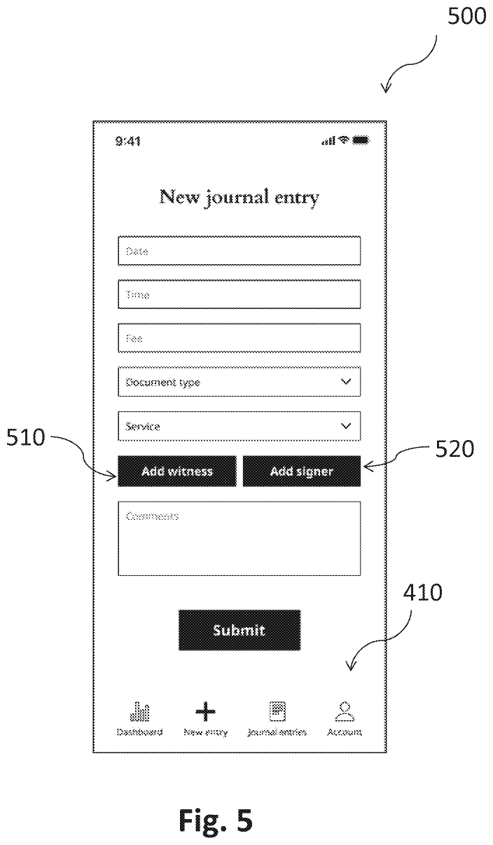

Selection of an add-entry option may cause the interface module 245 to present a transaction-entry screen 500, illustrated in FIG. 5. Through the transaction-entry screen 500, a user may initiate creation of an electronic journal entry by entering transaction information including notarial act type, transaction date, transaction time, fee information, document information, service information, jurisdictional information, or other transaction-related data. In some embodiments, the compliance-management module 270 dynamically determines required information based upon the selected transaction type and jurisdiction and automatically presents corresponding data-entry fields.

The transaction-entry screen 500 may further permit entry of information associated with one or more signatories and one or more witnesses. Selection of a signer option 520 may cause presentation of a signer-information screen 700, while selection of a witness option 510 may cause presentation of a witness-information screen 1000. The system may permit association of multiple signatories and multiple witnesses with a single journal entry. Participant information may be stored in structured records linked to the corresponding transaction identifier.

Through the signer-information screen 700, the system may receive participant information including names, addresses, contact information, identification information, credential information, and other participant-related data. The identity-verification module 252 may process the received information and may initiate one or more identity-verification procedures. In some embodiments, the identity-verification module obtains images of identification credentials through a document-capture interface 800. Images captured by the camera of the user device may be analyzed using image-processing and optical character recognition (OCR) techniques to extract identification data and security-feature information. Extracted information may be compared against one or more external verification sources to generate identity-verification results.

Upon capture of an identification credential, the geolocation module 265 may automatically obtain current geographic location information associated with the user device. The audit-management module 280 may further generate a corresponding event record containing a timestamp, transaction identifier, participant identifier, device identifier, and geographic location information. Similar event records may be generated upon capture of participant photographs, identity-verification operations, document scans, signature-capture operations, witness acknowledgments, and journal-entry submissions.

In some embodiments, the signature-capture module 260 presents a signature-capture interface 900 through which a participant may provide an electronic signature. The signature-capture module may capture signature image data, signature dynamics, biometric signature information, or combinations thereof. The signature-capture module may further authenticate the electronic signature using one or more authentication mechanisms including eKYC verification systems, biometric verification systems, digital certificates, public key infrastructure (PKI) systems, mobile identity credentials, or combinations thereof. Authentication results may be associated with the corresponding journal entry and participant record.

For each signature-capture event, identification-capture event, document-scan event, witness-capture event, and transaction-submission event, the geolocation module 265 may automatically obtain geographic coordinates and timestamp information from the user device. The obtained location and timestamp information may be cryptographically associated with the corresponding event record. The audit-management module 280 may correlate multiple event-specific location records and timestamps to generate a transaction-authenticity record indicative of whether the captured events occurred in a manner consistent with performance of the notarial transaction by the authenticated notary public. Such corroborated geolocation and timestamp information may provide a digital evidence trail useful for fraud detection, regulatory compliance, audits, and legal proceedings.

After collection of required information, the user may submit the transaction for journal generation. The journal-generation module 255 may automatically generate a journal entry comprising participant information, document information, verification results, signatures, timestamps, geolocation information, audit information, and transaction metadata. The generated journal entry may be assigned a unique transaction identifier and stored within one or more data repositories.

Selection of a search option may cause presentation of a record-search screen 1010. Through the record-search screen, the indexing and retrieval module 275 may permit searching of journal entries using participant names, journal identifiers, transaction identifiers, dates, date ranges, document types, locations, commission information, verification status, keywords, or combinations thereof. Search results may be displayed through the interface and may be filtered, sorted, grouped, exported, or otherwise processed.

In various embodiments, records identified through the search process may be exported in one or more formats including PDF, word-processing formats, spreadsheet formats, image formats, structured data formats, or combinations thereof. Exported records may be printed, electronically transmitted, attached to electronic communications, securely shared with authorized recipients, or stored within external systems. Prior to export, the cryptographic-security module 285 may verify record integrity and may apply encryption, digital signatures, access restrictions, or authentication controls.

Selection of an account-management option may cause presentation of a profile screen 1100 through which a user may view or modify account information, commission information, licensing information, authentication settings, security settings, retention preferences, or other profile-related information. The registration and authentication module 250 may validate modifications and maintain corresponding audit records.

Prior to storage, the cryptographic-security module 285 may generate one or more cryptographic hashes, digital signatures, certificates, verification tokens, or integrity-validation records associated with the journal entry. In certain embodiments, the journal entry or portions thereof may be encrypted, digitally signed by the notary public, cryptographically linked to prior journal entries, recorded within a blockchain or distributed ledger system, or combinations thereof. The resulting authenticated record may be stored together with searchable indexing information, thereby enabling efficient retrieval while preserving record integrity, authenticity, traceability, and non-repudiation.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A computer-implemented method for generating an authenticated electronic notary journal record, the method comprising:
receiving, by a processor from a portable user device, transaction information associated with a notarial transaction;
receiving information associated with at least one signer;
capturing, using a camera of the portable user device, an image of an identity credential associated with the at least one signer;
extracting identity information from the image of the identity credential;
transmitting the extracted identity information to an external verification system and receiving identity-verification data in response;
capturing, through the portable user device, a digital signature associated with the at least one signer;
generating a plurality of event records corresponding to transaction events performed during the notarial transaction, the transaction events including at least identity-credential capture, participant-photograph capture, document scanning, digital-signature capture, and journal-entry creation;
for each event record, automatically determining and recording geographic coordinate information and timestamp information corresponding to occurrence of the event using one or more location-determination services of the portable user device, and associating the geographic coordinate information and timestamp information with the event record;
correlating the geographic coordinate information and timestamp information associated with the plurality of event records to determine whether the transaction events satisfy one or more transaction-authentication criteria;
generating a transaction-authenticity record based on the determination;
generating an electronic journal entry comprising the transaction information, the extracted identity information, the identity-verification data, the digital signature, the plurality of event records, and the transaction-authenticity record;
generating a cryptographic integrity value associated with the electronic journal entry; and
storing the electronic journal entry and the cryptographic integrity value within a tamper-evident electronic record repository.

2. The method of claim 1, wherein extracting the identity information comprises performing optical character recognition on the image of the identity credential.

3. The method of claim 1, wherein the external verification system comprises a governmental database.

4. The method of claim 1, further comprising capturing a photograph of the at least one signer and associating the photograph with the electronic journal entry.

5. The method of claim 1, further comprising receiving information associated with at least one witness and associating the witness information with the electronic journal entry.

6. The method of claim 5, further comprising capturing an image of an identity credential associated with the at least one witness and verifying the identity credential associated with the at least one witness using the external verification system.

7. The method of claim 5, further comprising capturing a digital signature associated with the at least one witness.

8. The method of claim 1, wherein generating the transaction-authenticity record comprises determining whether geographic coordinate information associated with the plurality of event records remains within a predetermined geographic variance threshold during performance of the notarial transaction.

9. The method of claim 1, wherein generating the cryptographic integrity value comprises generating a cryptographic hash from the electronic journal entry and the plurality of event records.

10. The method of claim 9, further comprising recording the cryptographic hash within a blockchain network or distributed ledger system.

11. A system for generating an authenticated electronic notary journal record, the system comprising:
one or more processors;
one or more memories storing instructions that, when executed by the one or more processors, cause the system to:
receive, from a portable user device, transaction information associated with a notarial transaction;
receive information associated with at least one signer;
capture, using a camera of the portable user device, an image of an identity credential associated with the at least one signer;
extract identity information from the image of the identity credential;
transmit the extracted identity information to an external verification system and receive identity-verification data in response;
capture, through the portable user device, a digital signature associated with the at least one signer;
generate a plurality of event records corresponding to transaction events performed during the notarial transaction, the transaction events including at least identity-credential capture, participant-photograph capture, document scanning, digital-signature capture, and journal-entry creation;
for each event record, automatically obtaining geographic coordinate information and timestamp information from one or more location services of the portable user device and associating the geographic coordinate information and timestamp information with the event record;
correlate the geographic coordinate information and timestamp information associated with the plurality of event records to determine whether the transaction events satisfy one or more transaction-authentication criteria;
generate a transaction-authenticity record based on the determination;
generate an electronic journal entry comprising the transaction information, the extracted identity information, the identity-verification data, the digital signature, the plurality of event records, and the transaction-authenticity record;
generate a cryptographic integrity value associated with the electronic journal entry; and
store the electronic journal entry and the cryptographic integrity value within a tamper-evident electronic record repository.
